(19) United States
(12) Patent Application Publication
(10) Pub. No.: US 2025/0010508 A1
(43) Pub. Date: Jan. 9, 2025

(54) Positioning of a Position-Variable Stop Means of a Slicing Device for Slicing Food

(71) Applicant: GEA Food Solutions Germany GmbH, Biedenkopf-Wallau (DE)

(72) Inventor: Norbert Brunnquell, Altusried (DE)

(21) Appl. No.: 18/708,382

(22) PCT Filed: Nov. 8, 2022
(86) PCT No.: PCT/EP2022/081137

§ 371 Date: May 8, 2024

(30) Foreign Application Priority Data
Nov. 10, 2021 (DE) 10 2021 212 676.6

(51) Int. Cl. B26D 5/00; B26D 7/06

(52) U.S. Cl. CPC B26D 5/00; B26D 7/0633; B26D 7/0683; B26D 2210/02

(57) ABSTRACT

A slicing device for slicing food products that includes a cutting unit with a rotating cutting blade; and a feed unit for feeding the food products to be sliced to the cutting unit; the feed unit and/or the cutting unit has a position-variable stop means for guiding, holding, and/or positioning the food product; and the slicing device has a positioning aid in the form of a light source, which is configured to project a light marking for the position-variable stop means.

### CROSS-REFERENCE TO RELATED APPLICATIONS

This application is a US National Stage entry from PCT/EP2022/081137 filed on Nov. 8, 2022, which claims priority to DE 10 2021 212 676.6 filed on Nov. 10, 2021, the entireties of which are hereby incorporated by reference herein for all purposes.

### FIELD

The present invention is based on a slicing device for slicing food products, wherein the slicing device has a cutting unit with a rotating cutting blade and a feed unit for feeding the food products to be sliced to the cutting unit, and wherein the feed unit and/or the cutting unit has a position-variable stop means for guiding, holding and/or positioning the food product.

### BACKGROUND

In so-called slicers, or high-performance cutting machines, typically cylindrical or otherwise shaped food products, for example sausage, cheese, ham, raw ham, or the like, are cut into slices with a high cutting performance, for example up to 1000 cuts per minute or more. The food product is transported by means of a feed unit through a static cutting plane in the region of the cutting unit, in which the cutting is carried out by a rotating cutting blade, for example in the form of a circular or crescent blade in a cutting plane. The slice thickness is given by the distance by which the food product advances between two cuts. The cut slices are generally combined with a constant number of slices and/or defined weight to form portions and packaged.

Such cutting machines generally have product-guiding components such as grippers and guides, which are at least temporarily in contact with the food product and guide, support, drive and/or hold the food product during the transport to or through the cutting plane. These components are all subsumed in the context of the present invention under the term “stop means”. Since the slicing devices of the generic type are naturally intended to slice different food products, food products with very different geometries (calibers) are used on them. The stop means then needs to be adapted accordingly for each new food product. This adaptation is generally carried out manually by an operator of the slicing device and is therefore time-consuming and cost-intensive since the slicing device must not be in operation during the adaptation. In addition, the adaptation needs to be carried out precisely and carefully, since otherwise an incorrect cutting operation arises with high potential consequent costs, for example due to greater product waste, increased contamination of the machine or more wear, for example due to metal aberration in the product guides if there is direct contact between moving machine components. In the worst case, erroneous positioning may even entail damage to machine component parts, for example when a wrongly adjusted gripper impinges on the cutting strip and then presses it into the cutting blade.

A slicing device of the generic type is for example known from the publication WO 2017/186 498 A1, which likewise at least deals with the problem of the time-consuming changeover of the stop means. In order to solve this problem, this publication proposes the use of an adjustment mechanism in order to adapt the stop means. Although this simplifies the adjustment of the stop means, the problem that the operating safety of the slicing device depends on precise and careful manual positioning of the stop means is not solved.

### SUMMARY

It is an object of the present invention to provide a slicing device which does not have the disadvantages described in connection with the prior art and, in particular, allows reliable and rapid changeover for different foods with different calibers.

The object of the present invention is achieved by a slicing device according to these teachings.

According to the invention, the slicing device has a positioning aid in the form of a light source, which is configured to project a light marking for the position-variable stop means. Advantageously, a light marking is therefore generated for the stop means which marks a setpoint position for the stop means. An operator who is preparing the slicing device for a new food product with a caliber which differs from that of the previous food product, and for this purpose is repositioning the stop means, is therefore provided with precise information by the light marking in respect of the position to which they have to assign the stop means. The operating safety is therefore increased significantly since the precision and accuracy of the repositioning of the stop means is not dependent only on the subjective assessment of the operator. The changeover time may also be shortened significantly since the operator does not need to carry out elaborate manual remeasurement or estimation of the correct position. In particular, the light marking displays the setpoint position for the stop means to the operator, or the positioning aid is configured to project the light marking onto the setpoint position of the stop means. The position of the stop means may then be altered by a user manually or using a motor. It is also conceivable that the stop means is moved automatically into the correct position and a subsequent visual check is then merely carried out by the operator with the aid of the light marking. Because of the light marking, the operator immediately sees whether or not the stop means is that the correct position.

In the context of the present invention, the stop means preferably includes any product-guiding component of the slicing device that is product-specifically variable in its position in order to use the slicing device with different product calibers. Such stop means are in particular product guides that extend parallel to a main transport direction of the food toward a cutting plane and guide the food product laterally, from above or from below, or end stops that are located transversely to the main transport direction before or after the food product and function as an end stop for the food product (for example when filling a lane), or grippers that engage in a rearward end of the food product as seen in the main transport direction, or transport means that are in direct contact with the food product and transport the food product in the direction of the cutting plane.

According to one preferred embodiment of the present invention, the stop means can be fastened position-variably in a feed plane, the positioning aid being configured to project the light marking into the feed plane and/or onto the stop means, the light marking preferably being projected from above into the feed plane. Alternatively, it is conceivable that the light marking is shined by the light source laterally or from the rear as seen (in the main transport direction). Projection from the rear could advantageously always take place at the same angle as the angle of the feed plane, particularly if the product feed is configured to be tiltable.

Preferably, the light source comprises an LED and/or a laser, preferably a line, cross or spot laser. Advantageously, the exact setpoint position of the stop means in the feed plane, that is to say in two mutually independent spatial directions, may therefore be established. It is also conceivable that not only the precise position but also the orientation of the stop means in the feed plane is specified with the aid of the light marking. Furthermore preferentially, a stop means specification and/or a product type specification is also projected onto the position of the stop means in addition to the setpoint position. It is also conceivable that numbers for numerical specification of the stop means or even part numbers are displayed so that the operator immediately sees for which stop means the position displayed by the light marking is intended. The machine operation and changeover are therefore made much more intuitive and less susceptible to error for the operator.

According to one preferred embodiment of the present invention, the positioning aid comprises two light sources, a first light source, in particular a laser, comprising for projecting the light marking and/or a second light source, in particular an LED, for projecting a stop means specification and/or a product type specification. Typically, slicing devices of the generic type are equipped with a plurality of stop means. Advantageously, the operator who is carrying out the changeover of the machine is thus displayed not only the position at which a stop means should be arranged but also the stop means which is to be arranged there, by a stop means specification being displayed, for example a number or a name of the stop means in question.

Further, it is conceivable that the food product for which the positioning is carried out is indicated by also indicating the product specification, so that at least an approximate plausibility check may be performed by the operator.

According to one preferred embodiment of the present invention, the positioning aid is configured, with the aid of product-specific positioning data, to project light markings at predetermined positions and/or in predetermined alignments in order to mark the setpoint position of the stop means, the slicing device having a control unit connected to a memory unit, the control unit being configured to read product-specific positioning data from the memory unit and transmit them to the positioning aid. Advantageously, a multiplicity of different product-specific position data for various products that can be sliced with the slicing device in question may therefore be pre-stored in the memory of this slicing device. If one of these products is then intended to be sliced, the associated positioning data merely need to be read from the memory and transmitted to the positioning aid, which then displays the appropriate positions of the stop means for the food products to be sliced, so that these stop means can be arranged at the corresponding location automatically or by the operator, manually or using a motor.

Preferably, the control unit has an input unit by means of which a product type can be specified, the product-specific positioning data being selected from the memory unit with the aid of the product type. Such an input unit may for example be an entry medium such as a touch panel, a keypad or a voice or gesture control, via which the operator selects on the slicing device a particular product that is intended to be sliced next, so that the associated positioning data can be read from the memory. Alternatively, it is also conceivable that the operator enters the dimensions of a new product by means of the input unit and the control unit calculates therefrom the correct positioning data for the positioning aid, or the stop means.

A further subject of the present invention, in order to achieve the object stated in the introduction, is a method for positioning a position-variable stop means, in particular of a slicing device according to these teachings.

The method according to the invention comprises at least two method steps, a setpoint position for the stop means being marked with the aid of a light marking in a first method step, and the stop means being positioned with the aid of the light marking in a second method step. In a similar way to the device according to the invention, with the method according to the invention the changeover of the slicing device to food with a different caliber can advantageously also be carried out more precisely, more reliably and more rapidly by the setpoint position for the stop means being pre-marked by the light marking. In order to avoid repetitions, the comments made above for the device according to the invention apply equally for the method according to the invention, and vice versa.

According to one preferred embodiment of the present invention, a product type is specified in a first substep of a zeroth method step preceding the first method step, product-specific positioning data being loaded from a memory unit with the aid of the product type and transmitted to a position aid in a second substep of the zeroth method step. Preferably, the light marking is then projected by the positioning aid onto the setpoint position as a function of the product-specific positioning data in the first method step.

Preferably, a light marking in the form of a line, spot or cross is projected by the positioning aid onto the setpoint position in order to mark the setpoint position.

Furthermore preferentially, a stop means specification and/or a product type specification is projected onto the position of the stop means in addition to the setpoint position.

Further details, features and advantages of the invention may be found in the drawings and the following description of preferred embodiments with the aid of the drawings. The drawings illustrate merely exemplary embodiments of the invention, which do not restrict the essential inventive concept.

### BRIEF DESCRIPTION OF THE DRAWINGS

FIG. 1 shows a schematic view of the slicing device according to an exemplary embodiment of the present invention.

FIG. 2 shows a perspective detail view of the slicing device according to the exemplary embodiment of the present invention.

### DETAILED DESCRIPTION

In the various figures, parts that are the same are always provided with the same reference signs and in general are also therefore respectively named, or mentioned, only once.

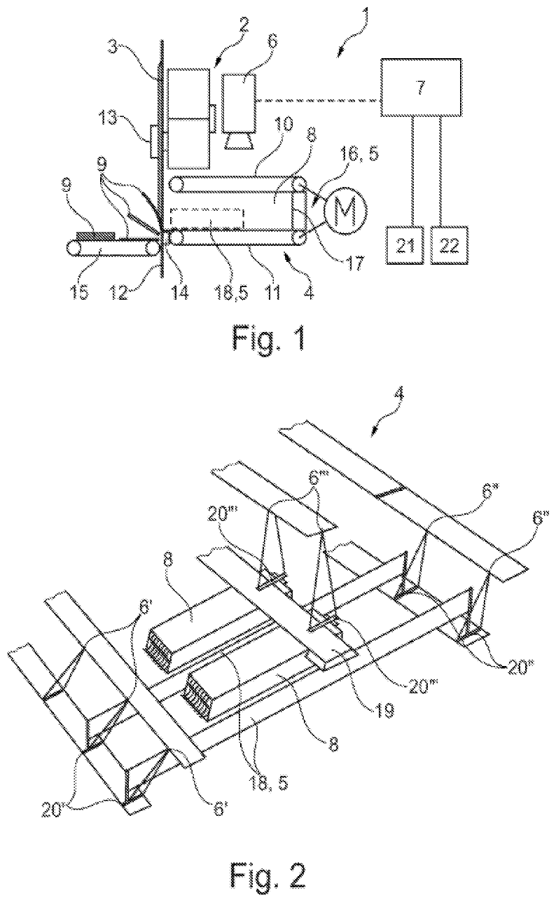

In FIG. 1 is a schematic side view of a slicing device 1 according to an exemplary embodiment of the present invention. The slicing device 1 has a cutting unit 5 with a rotating cutting blade 3, which cuts a food product 8 into food slices 9. The cutting blade 3 comprises a circular blade rotating about a rotation axis or a crescent blade which rotates about a rotation axis that executes an orbital movement.

The food product 8 is fed to the cutting unit 5 by means of a feed unit 4 of the slicing device 1. The feed unit 4 for this purpose in the present example has two conveyor belts 10, 11, which transport the food product 8 continuously or intermittently in the direction (also referred to as the main transport direction) of the cutting plane 12 of the cutting blade 3. The lower conveyor belt 11 forms a product support, on which the food product 8 rests or bears during loading and/or slicing. The cutting blade 3 is fastened on a rotating blade holder 13 and preferably cooperates for cutting with a cutting edge 13 that is provided for example on the front end of the product support. The cutting blade 3 rotates inside the cutting plane 12, so that the rotation axis of the cutting blade 3 is perpendicular to the cutting plane 12.

Between the cutting blade 3 on the cutting edge 14, there is a so-called cutting gap, which should be as small as possible but must be large enough that the blade does not touch the cutting edge. This gap needs to be adjusted regularly. This may be done by moving the cutting blade 3 and/or the cutting edge 14. The cutting edge 14 must furthermore be aligned parallel to the cutting blade 3. After the slicing, the food slices 9 separated from the food product 8 generally fall onto a delivery table 15. On the delivery table 15, the food slices 9 are arranged in portions, in particular a plurality of food slices 9 stacked on one another and/or overlapping. The delivery table 15 has further transport means for transporting away the food slices 9, or portions, for example in the form of a transport band or a transport belt. The finished portions are thus transported away from the cutting unit 2 and then packaged.

The feed unit 4 further has a plurality of stop means 5 which guide, contact and/or grip the food product 8 during the feeding to or through the cutting plane 12. The feed unit 4 has, for example, a gripper 16 which engages into a rearward end 17, as seen in the main transport direction, of the food product 8 before or during the slicing and stabilizes it during the slicing, in particular toward the end of the slicing process, and disposes of the end piece that cannot be sliced. The gripper 16 is preferably fastened on a carrier 19 (see FIG. 2) which moves the gripper 16 forward and back parallel to the main transport direction of the food product 8. The position of the gripper 16 on the carrier 19 and/or the position of the entire carrier 19 can be adjusted, i.e. the gripper 16 is position-variable in order to be able to accommodate different product geometries. The gripper 16 is a stop means 5 in the context of the present invention. In order to guide the food product 9 when loading the slicing device 1 and/or when slicing the food product 9, the feed unit 4 further has a plurality of product guide means 18, which likewise form stop means 5 in the context of the present invention. The product guide means 18 extend parallel to the main transport direction of the food products 9 and are provided position-variably, that is to say adjustably, in particular transversely to the main transport direction, in order to accommodate food products 8 with different calibers. It is conceivable that at least two such product guide means 18 are provided, one of the two product guide means 18 being arranged on each side of the food product 8 so that the food product 8 is guided on both sides during the transport in the direction of the cutting plane.

The position of the stop means 5 always needs to be adjusted to the caliber, that is to say the diameter, the height and the width of the food product 8 to be sliced. For this purpose, the stop means 5 are configured position-variably. If a new food product 8 is intended to be sliced with the slicing device 1 according to the invention and its caliber (that is to say its diameter, height, width and other shaping) differs from the caliber of the previously sliced food product 8, the positions of the stop means 5 are readjusted by an operator of the slicing device 1 manually or using a motor by means of corresponding actuators. For each caliber, there is an optimal position at which the stop means 5 should be arranged so as to ensure an optimal and reliable cutting operation. This optimal position, at which the operator has to position the stop means 5, is referred to as a setpoint position.

In order to find this individual setpoint position for the respective stop means 5, the slicing device 1 has a positioning aid 6 with a light source, which respectively projects a light marking 20 in the form of a line, spot or a cross onto the location of the setpoint position. The operator then sees the setpoint position for the respective stop means 5 directly and can compare the actual position with the setpoint position, and place the stop means 5 directly at the setpoint position if there is a discrepancy.

The positioning aid 6 comprises in particular a laser or LED, which is arranged above the feed plane of the feed unit 4 and shines light downward into the feed plane. The light marking 20 resulting therefrom is located particularly in the region of the feed plane and/or on the carrier 19. The intensity and color (preferably red) of the laser is in particular selected in such a way that there is no risk of eye injuries to the operator.

It is conceivable that the slicing device 1 has a control unit 7, which correspondingly controls the positioning aid 6 so that it projects the light markings 20 onto the correct setpoint positions. The control unit 7 is for this purpose preferably connected both to an input unit 21 and to a memory unit 22. The memory unit 22 preferably has a database in which a multiplicity of product-specific setpoint positions for various food products 8 are stored. The input unit 21 comprises in particular a touch panel, a scanner, a keypad or voice or gesture control.

The operator can determine the food product 8 to be newly sliced via the input unit 21, for example by a product type being selected on the touch panel or a product identifier or reference number being entered by the operator via the touch panel or a keypad and/or an identification code assigned to the food product 8, for example a barcode or a QR code, being scanned by the scanner. The product-specific setpoint positions (also referred to as product-specific positioning data) for this food product 8 are then retrieved by the control unit 7 from the database of the memory unit 22 and the positioning aid 6 is controlled accordingly.

Alternatively, it is also conceivable that the operator enters the precise dimensions of the food product 8 to be newly sliced by means of the input unit and that the control unit 7 calculates the setpoint positions for the stop means 5 by itself. Further, it would also be conceivable that the operator enters the setpoint positions directly via the input unit.

The procedure described above corresponds to the method according to the invention for positioning the position-variable stop means.

The side view of FIG. 1 shows only one lane of the slicing device 1. Preferably, however, the slicing device 1 is designed with multiple lanes as may be seen in FIG. 2, by at least one further lane for feeding and slicing food products 8 being provided in a similar fashion to the lane depicted in FIG. 1. Each lane then has one or more grippers 16 as well as at least one product guide means 18.

FIG. 2 represents a perspective detail view of the feed unit 4 of the slicing device 1 illustrated above with the aid of FIG. 1.

Arranged above the feed unit 4, there are by way of example three positioning aids 6′, 6″ and 6″, each of which has a plurality of light sources in the form of line lasers. The first and last positioning aids 6′ and 6″ each project light markings 20′, 20″ in the form of lines parallel to the main transport direction into the feed plane, and these indicate the respective setpoint positions for the product guide means 18 arranged laterally next to each lane.

The central positioning aid 6″ projects light markings 20″ in the form of lines onto the upper side of the carrier 19 in order to indicate the setpoint position of the gripper 16 on the carrier 19.

It is also conceivable not only that the light markings 20 for the setpoint positions of the various stop means 20 are projected into the feed plane by the positioning aid 6, but also that a stop means specification is also projected into the vicinity of the light marking 20 by means of further light markings (not illustrated). The operator therefore knows not only where the stop means 5 are to be arranged, but also which light marking 20 is intended for which stop means 5. This prevents erroneous arrangement of the stop means 5. In addition, it is also conceivable that a product type specification is projected into the feed plane, so the operator can verify that the correct product type has been selected on the input unit 21 and the correct setpoint positions have therefore also been loaded and displayed.

### LIST OF REFERENCE SIGNS

1 slicing device
2 cutting unit
3 cutting blade
4 feed unit
5 stop means
6 positioning aid
7 control unit
8 food product
9 food slices
10 upper conveyor belt
11 lower conveyor belt
12 cutting plane
13 blade holder
14 cutting edge
15 delivery table
16 gripper
17 food product end
18 product guide means
19 carrier
20 light marking
21 input unit
22 memory unit

1. A slicing device for slicing food products, comprising
a cutting unit with a rotating cutting blade; and
a feed unit for feeding the food products to be sliced to the cutting unit;
wherein the feed unit and/or the cutting unit has a position-variable stop means for guiding, holding, and/or positioning the food product; and
wherein the slicing device has a positioning aid in the form of a light source, which is configured to project a light marking for the position-variable stop means.

2. The slicing device as claimed in claim 1, wherein a position of the position-variable stop means can be altered by a user manually or using a motor, and the positioning aid is configured to project the light marking on a setpoint position of the variable stop means.

3. The slicing device as claimed in claim 1, wherein the able stop means can be fastened position-variably in a feed plane, the positioning aid being configured to project the light marking into the feed plane and/or onto the position-variable stop means, the light marking being projected from above into the feed plane.

4. The slicing device as claimed in claim 1, wherein the light source comprises an LED and/or a laser, a line, cross or spot laser.

5. The slicing device as claimed in claim 4, wherein the positioning aid comprises two light sources, a first light source that is a laser for projecting the light marking and a second light source that is an LED for projecting a stop means specification and/or a product type specification.

6. The slicing device as claimed in claim 1, wherein the position-variable stop means comprises a gripper for gripping a rearward end of a food product to be sliced.

7. The slicing device as claimed in claim 1, wherein the positioning aid is configured, with the aid of product-specific positioning data, to project light markings at predetermined positions and/or in predetermined alignments in order to mark a setpoint position of the position-variable stop means.

8. The slicing device as claimed in claim 7, wherein the slicing device has a control unit connected to a memory unit, the control unit being configured to read product-specific positioning data from the memory unit and transmit them to the positioning aid.

9. The slicing device as claimed in claim 8, wherein the control unit has an input unit by means of which a product type can be specified, the product-specific positioning data being selected by the control unit from the memory unit with the aid of the product type.

10. A method for positioning the position-variable stop means of a slicing device as claimed in claim 1, wherein a setpoint position for the stop means is marked with aid of the light marking in a first method step, and the stop means is positioned with aid of the light marking in a second method step.

11. The method as claimed in claim 10, wherein a product type is specified in a first substep of a zeroth method step preceding the first method step, product-specific positioning data being loaded from a memory unit with aid of the product type and transmitted to a position aid in a second substep of the zeroth method step.

12. The method as claimed in claim 11, wherein the light marking is projected by the positioning aid onto the setpoint position in the first method step as a function of the product-specific positioning data.

13. The method as claimed in claim 10, wherein the light marking in the form of a line, spot or cross is projected by the positioning aid onto the setpoint position in order to mark the setpoint position.

14. The method as claimed in claim 10, wherein a stop means specification and/or a product type specification is projected onto the position of the position-variable stop means in addition to the setpoint position.
